(19) United States
(12) Patent Application Publication
(10) Pub. No.: US 2016/0277059 A1
(43) Pub. Date: Sep. 22, 2016

(54) SEMICONDUCTOR DEVICE

(71) Applicant: KABUSHIKI KAISHA TOSHIBA, Tokyo (JP)

(72) Inventor: Yutaka Yadoumaru, Kawasaki Kanagawa (JP)

(21) Appl. No.: 14/845,044

(22) Filed: Sep. 3, 2015

(30) Foreign Application Priority Data
Mar. 16, 2015 (JP) 2015-052556

(51) Int. Cl. H04B 1/44; H04B 15/00

(52) U.S. Cl. CPC H04B 1/44; H04B 15/00

(57) ABSTRACT

A semiconductor device according to an embodiment comprises a first terminal receiving a high-frequency signal as an input and a second terminal outputting the high-frequency signal. A first switching part is provided on a path of the high-frequency signal between the first terminal and the second terminal. A second switching part and an inductor are connected in series between the first terminal and a reference voltage source. The second switching part is in a conduction state to short-circuit the first terminal with the reference voltage source when the first switching part is in a non-conduction state. The second switching part is in a non-conduction state when the first switching part is in a conduction state.

### CROSS REFERENCE TO RELATED APPLICATIONS

This application is based upon and claims the benefit of priority from the prior Japanese Patent Application No. 2015-052556, filed on Mar. 16, 2015, the entire contents of which are incorporated herein by reference.

### FIELD

The embodiments of the present invention relate to a semiconductor device.

### BACKGROUND

In recent years, communication devices such as a smartphone and a tablet terminal are increasingly adapted to support multiple bands and a plurality of transmission circuits or reception circuits are sometimes provided in one communication device to simultaneously perform transmission and reception (a carrier aggregation system). In such a case, a harmonic of the frequency of a transmission signal may overlap with the frequency band of a reception signal from the other side in one communication device. In this case, the transmission signal from the communication device itself becomes an interference wave to the reception signal, which becomes a factor of deterioration in the reception performance.

### BRIEF DESCRIPTION OF THE DRAWINGS

FIG. 1 is a block diagram showing a configuration example of a transmitter/receiver of a communication device 1 according to a first embodiment;

FIG. 2 is a block diagram showing an example of a configuration of a high-frequency switching circuit 10 included in the transmitter TRM or the receiver RCV;

FIG. 3 is a circuit diagram showing an example of an internal configuration of the switching region SWR of the transmitter TRM according to the first embodiment;

FIGS. 4A and 4B are graphs showing relations between the signal strength of the transmitted high-frequency signal St and the frequency thereof, respectively; and

FIG. 5 is a circuit diagram showing an example of an internal configuration of the switching region SWR according to a second embodiment.

### DETAILED DESCRIPTION

Embodiments will now be explained with reference to the accompanying drawings. The present invention is not limited to the embodiments.

A semiconductor device according to an embodiment comprises a first terminal receiving a high-frequency signal as an input and a second terminal outputting the high-frequency signal. A first switching part is provided on a path of the high-frequency signal between the first terminal and the second terminal. A second switching part and an inductor are connected in series between the first terminal and a reference voltage source. The second switching part is in a conduction state to short-circuit the first terminal with the reference voltage source when the first switching part is in a non-conduction state. The second switching part is in a non-conduction state when the first switching part is in a conduction state.

### First Embodiment

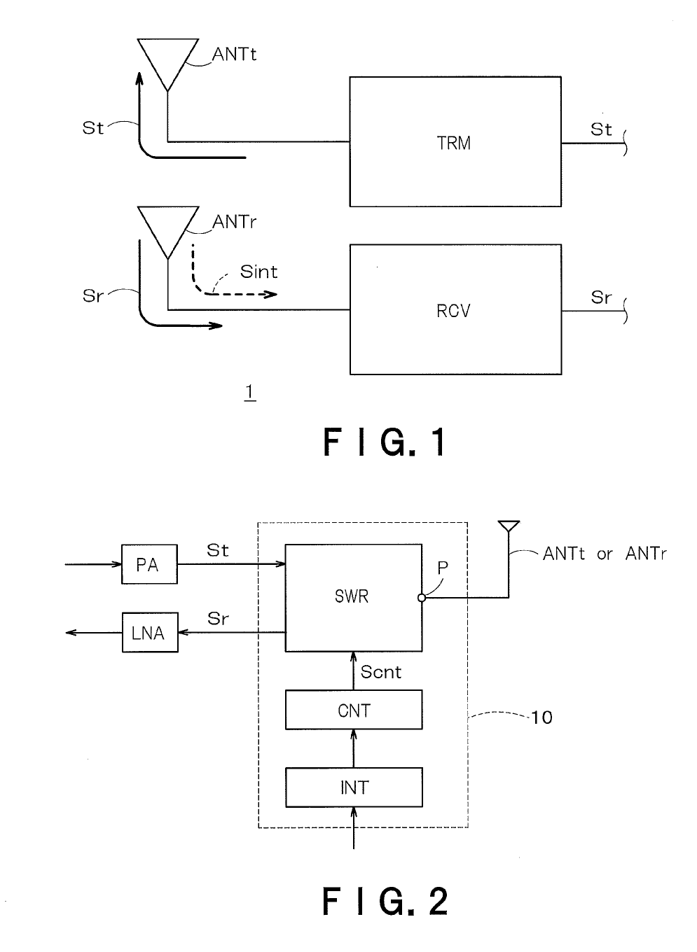

FIG. 1 is a block diagram showing a configuration example of a transmitter/receiver of a communication device 1 according to a first embodiment. The communication device 1 is a communication device such as a smartphone or a tablet terminal and includes a transmitter TRM, a receiver RCV, and antennas ANTt and ANTr. The communication device 1 includes the antenna ANTt for transmission and the antenna ANTr for reception and adopts a carrier aggregation system that enables to simultaneously perform transmission and reception. In FIG. 1, a transmitter/receiver of a high-frequency signal is shown and illustrations of other constituent elements of the communication device 1 are omitted.

The transmitter TRM receives a high-frequency signal St transmitted from the communication device 1 and outputs the high-frequency signal St from the antenna ANTt. The transmitter TRM has a high-frequency switching circuit and can selectively transmit the high-frequency signals St of a plurality of frequency bands via the antenna ANTt. For example, the transmitter TRM can selectively transmit high-frequency signals to be used in communication systems (such as a CDMA (Code Division Multiple Access) and a GSM (Global System for Mobile)®) having different frequency bands.

The receiver RCV receives a high-frequency signal Sr via the antenna ANTr to be received by the communication device 1 and takes the high-frequency signal Sr in the communication device 1. The receiver RCV also has a high-frequency switching circuit and can selectively receive the high-frequency signals Sr of a plurality of frequency bands via the antenna ANTr. For example, the receiver RCV can selectively receive high-frequency signals to be used in communication systems (such as the CDMA and the GSM) having different frequency bands.

FIG. 1 illustrates a state where the transmitter TRM transmits a signal and the receiver RCV receives a signal. However, the transmitter TRM can be configured to be capable of receiving a signal as well as transmitting a signal. The receiver RCV also can be configured to be capable of transmitting a signal as well as receiving a signal.

FIG. 2 is a block diagram showing an example of a configuration of a high-frequency switching circuit 10 included in the transmitter TRM or the receiver RCV. The high-frequency switching circuit 10 includes a switching region SWR, a controller CNT, and an interface part INT. The high-frequency switching circuit 10 can be a semiconductor integrated circuit device provided on an SOI (Silicon On Insulator) substrate as one semiconductor chip.

The interface part INT receives serial data to be used to generate a control signal Scnt as an input through an input terminal and converts the serial data to parallel data (a switching signal). For this purpose, the interface part INT has a serial-parallel conversion circuit and is constituted of a digital LSI (Large Scale Integration) highly integrated and capable of a high-speed operation.

The controller CNT receives the parallel data (the switching signal) from the interface part INT and converts the voltage of the parallel data to a predetermined voltage to generate the control signal Scnt and output the control signal Scnt. The control signal Scnt is used to execute on/off control of a switching element in the switching region SWR. For this purpose, the controller CNT boosts the voltage of the parallel data to a sufficiently high voltage to turn on a switching element and generates the control signal Scnt.

In a case of signal transmission, the switching region SWR outputs the high-frequency signal St to the antenna ANTt based on the control signal Scnt. In a case of signal reception, the switching region SWR transmits the high-frequency signal Sr acquired via the antenna ANTr to a reception LNA (Low Noise Amplifier) based on the control signal Scnt. A more detailed configuration of the switching region SWR is explained later.

A transmission power amplifier PA outputs the high-frequency signal St to the high-frequency switching circuit 10 after amplifying the power thereof to desired power. The reception LNA amplifies the power of the high-frequency signal Sr received by the antenna ANTr.

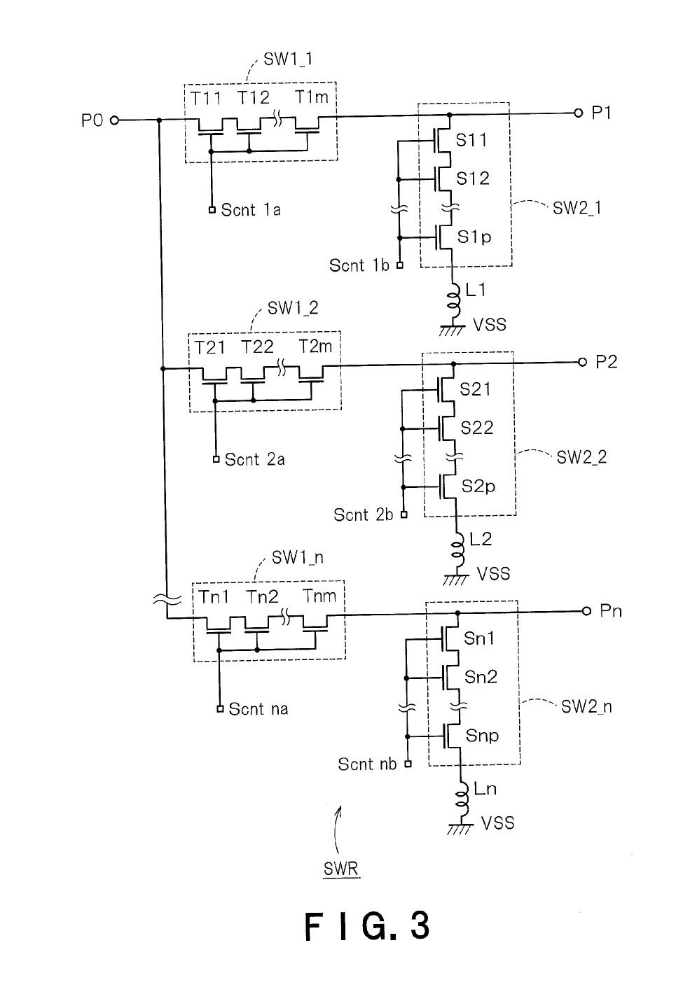

FIG. 3 is a circuit diagram showing an example of an internal configuration of the switching region SWR of the transmitter TRM according to the first embodiment. The switching region SWR includes first terminals P1 to Pn (n is a natural number), a second terminal P0, first switching parts SW1_1 to SW1_n, second switching parts SW2_1 to SW2_n, and inductors L1 to Ln.

The first terminals (ports) P1 to Pn are connected to, for example, the transmission power amplifier PA and receive as an input the high-frequency signal St from the transmission power amplifier PA.

The second terminal P0 is connected to, for example, the antenna ANTt and outputs (transmits) the high-frequency signal St from the antenna ANTt. The second terminal P0 is a common port provided in common to the first terminals P1 to Pn.

The first switching parts SW1_1 to SW1_n are connected between the first terminals P1 to Pn and the second terminal P0 and are provided on paths of the high-frequency signal St, respectively. The first switching parts SW1_1 to SW1_n connect or disconnect the paths of the high-frequency signal St between the first terminals P1 to Pn and the second terminal P0 by being brought into a conduction state or a non-conduction state, respectively. Accordingly, the first switching parts SW1_1 to SW1_n can selectively pass or block the high-frequency signal St input from the first terminals P1 to Pn to the second terminal P0, respectively. For example, when the first switching part SW1_1 is in a conduction state and the first switching parts SW1_2 to SW1_n are in a non-conduction state, the high-frequency signal St input from the first terminal P1 is passed to the second terminal P0 and the high-frequency signal St input from the first terminals P2 to Pn is blocked. In this way, the communication device 1 can selectively transmit the high-frequency signal St from the first terminal P1.

The first switching parts SW1_1 to SW1_n respectively have m (m is a natural number) MOS transistors (T11 to T1m, T21 to T2m, T31 to T3m, . . . Tn1 to Tnm). The first switching part SW1_1 includes the MOS transistors T11 to T1m connected in series between the first terminal P1 and the second terminal P0. Gates of the MOS transistors T11 to T1m are connected in common and receive a control signal Scnt1a from the controller CNT. The MOS transistors T11 to Tim are controlled to be on/off by the control signal Scnt1a. The first switching part SW1_2 includes the MOS transistors T21 to T2m connected in series between the first terminal P2 and the second terminal P0. Gates of the MOS transistors T21 to T2m are connected in common and receive a control signal Scnt2a from the controller CNT. The MOS transistors T21 to T2m are controlled to be on/off by the control signal Scnt2a. Similarly, other first switching part SW1_k (k=3 to n) includes the MOS transistors Tk1 to Tkm connected in series between the first terminal Pk and the second terminal P0. Gates of the MOS transistors Tk1 to Tkm receive a control signal Scntka from the controller CNT. The MOS transistors Tk1 to Tkm are controlled to be on/off by the control signal Scntka.

Each of the first switching parts SW1_1 to SW1_n is constituted of the MOS transistors. This enhances breaking characteristics (an off capacitance and an off breakdown voltage) of the high-frequency signal at an off time. For example, when the first switching part SW1_1 is selected and the first switching part SW1_1 outputs the high-frequency signal St from the first terminal P1 to the second terminal P0, other non-selected first switching parts SW1_2 to SW1_n are in a non-conduction state. At this time, it is undesirable that the high-frequency signal St from the first switching part SW1_1 propagates to other first terminals P2 to Pn via the non-selected first switching parts SW1_2 to SW1_n. Therefore, by constituting each of the first switching parts SW1_1 to SW1_n of the MOS transistors, the first switching parts SW1_1 to SW1_n can reliably block the high-frequency signal while in a non-conduction state.

The second switching part SW2_1 and the inductor L1 are connected in series between the first terminal P1 and a reference voltage source VSS (a ground voltage source, for example). The second switching part SW2_2 and the inductor L2 are connected in series between the first terminal P2 and the reference voltage source VSS. Similarly, the second switching part SW2_k (k=3 to n) and the inductor Lk are connected in series between the first terminal Pk and the reference voltage source VSS (the ground voltage source, for example).

The second switching parts SW2_1 to SW2_n connect or disconnect between the first terminals P1 to Pn and the reference voltage source VSS by being brought into a conduction state or a non-conduction state, respectively. When the second switching parts SW2_1 to SW2_n are in a conduction state, the second switching parts SW2_1 to SW2_n shunt the first terminals P1 to Pn to the reference voltage source VSS via the inductors L1 to Ln, respectively.

The second switching parts SW2_1 to SW2_n operate complementarily with the first switching parts SW1_1 to SW1_n, respectively. For example, when the first switching part SW1_1 is in a conduction state and the first switching parts SW1_2 to SW1_n are in a non-conduction state, the second switching part SW2_1 is in a non-conduction state and the second switching parts SW2_2 to SW2_n are in a conduction state. The second switching part SW2_1 thereby does not shunt the first terminal P1 to the reference voltage source VSS. Therefore, the high-frequency signal St from the first terminal P1 can be output to the second terminal P0 via the first switching part SW1_1. Meanwhile, other second switching parts SW2_2 to SW2_n shunt the first terminals P2 to Pn to the reference voltage source VSS, respectively. Therefore, if the high-frequency signal St from the first terminal P1 propagates through the first switching parts SW1_2 to SW1_n in a non-conduction state and travels toward the first terminals P2 to Pn, the second switching parts SW2_2 to SW2_n can release the high-frequency signal St toward the reference voltage source VSS.

The switching parts SW2_1 to SW2_n respectively include p (p is a natural number) MOS transistors (S11 to S1p, S21 to S2p, S31 to S3p, . . . Sn1 to Snp). The second switching part SW2_1 includes the MOS transistor S11 to S1p connected in series between the first terminal P1 and the inductor L1. Gates of the MOS transistors S11 to S1p are connected in common and receive a control signal Scnt1b from the controller CNT. The MOS transistors S11 to S1p are controlled to be on/off by the control signal Scnt1b. The second switching part SW2_2 includes the MOS transistors S21 to S2p connected in series between the first terminal P2 and the inductor L2. Gates of the MOS transistors S21 to S2p are connected in common and receive a control signal Scnt2b from the controller CNT. The MOS transistors S21 to S2p are controlled to be on/off by the control signal Scnt2b. Similarly, the second switching part SW2_k (k=3 to n) includes the MOS transistors Sk1 to Skp connected in series between the first terminal Pk and the inductor Lk. Gates of the MOS transistors Sk1 to Skp receive a control signal Scntkb from the controller CNT. The MOS transistors Sk1 to Skp are controlled to be on/off by the control signal Scntkb.

Each of the second switching parts SW2_1 to SW2_n is constituted by connecting the MOS transistors in series. Accordingly, for example, when the first switching part SW1_1 is in a conduction state and the second switching part SW2_1 is in a non-conduction state, the high-frequency signal St that is to be transmitted from the first terminal P1 to the second terminal P0 can be suppressed from leaking to the reference voltage source VSS via the second switching part SW2_1 and the inductor L1.

In the first embodiment, the inductors L1 to Ln are connected between the second switching parts SW2_1 to SW2_n and the reference voltage source VSS, respectively. Therefore, when the second switching parts SW2_1 to SW2_n are in a non-conduction state, LC series circuits are formed by the second switching parts SW2_1 to SW2_n and the inductors L1 to Ln, respectively. The LC series circuits can shunt a high-frequency signal of a predetermined frequency band to the reference voltage source VSS. For example, assuming that an off capacitive component of the second switching part SW2_1 is Csw2 and that an inductance of the inductor L1 is L1_1, an LC series circuit formed by the second switching part SW2_1 and the inductor L1 can pass (release) a high-frequency signal of a band centered around a frequency Fc indicated by Expression 1 to the reference voltage source VSS.

Fc=½n(Csw2×L1_1)^{1/2} [Hz] (Expression 1)

That is, the LC series circuit formed by the second switching part SW2_1 and the inductor L1 can attenuate a signal of a frequency band centered around the frequency Fc among the high-frequency signals St passing from the first terminal P1 to the second terminal P0.

The frequency Fc can be adjusted by changing the off capacitive component Csw2 of the second switching part SW2_1 and/or the inductance L1_1 of the inductor L1 according to Expression 1. For example, the off capacitive component Csw2 can be changed by changing the number of the MOS transistors connected in series in the second switching part SW2_1. The inductance L1_1 can be changed by changing the length of the inductor L1. In this way, the LC series circuit formed by the second switching part SW2_1 and the inductor L1 can attenuate a signal of a predetermined frequency band. The off capacitive component Csw2 of the second switching part SW2_1 and the inductance L1_1 of the inductor L1 are fixed after manufacturing of a semiconductor chip of the switching circuit 10. Accordingly, in the first embodiment, the frequency band attenuated from that of the high-frequency signal St is also fixed after manufacturing of the semiconductor chip of the switching circuit 10.

Other second switching parts SW2_2 to SW2_n and other inductors L2 to Ln can similarly form LC series circuits, respectively. The LC series circuits formed by the second switching parts SW2_1 to SW2_n and the inductors L1 to Ln, respectively can attenuate signals of different frequency bands.

Next, a transmission operation of the switching region SWR is explained next. In this example, the switching region SWR is assumed to output the high-frequency signal St from the first terminal P1 to the second terminal P0. In this case, the controller CNT selects the first switching part SW1_1 from among the first switching parts SW1_1 to SW1_n and brings the selected first switching part SW1_1 into a conduction state. The controller CNT brings the second switching part SW2_1 corresponding to the selected first switching part SW1_1 into a non-conduction state. At this time, the second switching part SW2_1 has the off capacitive component Csw2. Accordingly, the first switching part SW1_1 connects the corresponding first terminal P1 to the second terminal P0 and passes the high-frequency signal St from the first terminal P1 to the second terminal P0. The high-frequency signal St is transmitted from the second terminal P0 via the antenna ANTt. The second switching part SW2_1 and the inductor L1 form the LC series circuit and attenuate a signal of a predetermined frequency band among the high-frequency signals St passing through the first switching part SW1_1.

Meanwhile, the non-selected first switching parts SW1_2 to SW1_n are in a non-conduction state. At this time, the second switching parts SW2_2 to SW2_n corresponding to the non-selected first switching parts SW1_2 to SW1_n are brought into a conduction state to shunt the first terminals P2 to Pn corresponding to the non-selected first switching parts SW1_2 to SW1_n to the reference voltage source VSS, respectively.

In this way, the switching circuit 10 can selectively transmit the high-frequency signal St from the first terminal P1 while attenuating a signal of a predetermined frequency band among the high-frequency signals St.

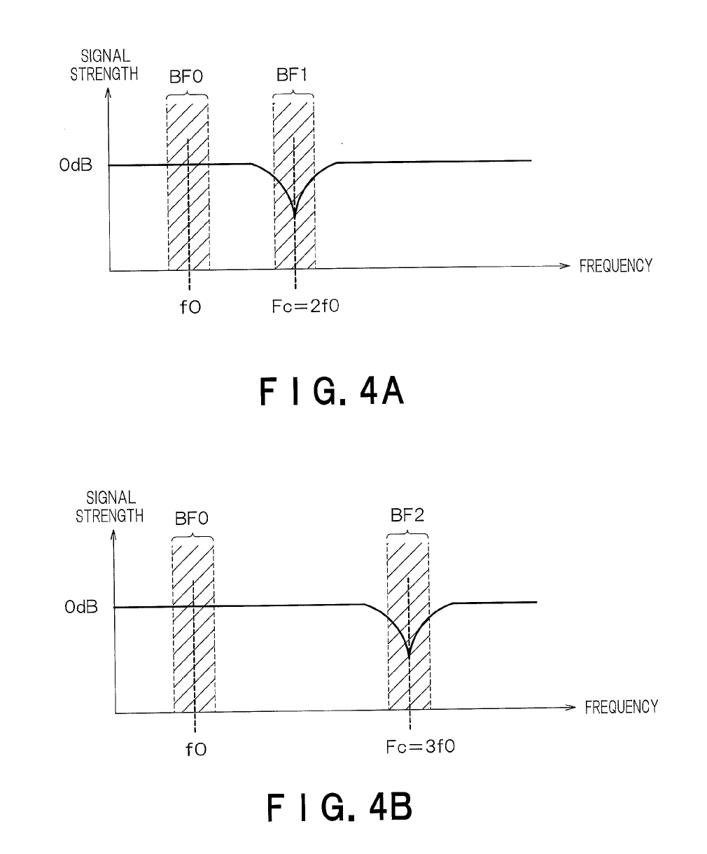

FIGS. 4A and 4B are graphs showing relations between the signal strength of the transmitted high-frequency signal St and the frequency thereof, respectively. The vertical axis represents the signal strength of the high-frequency signal St and the horizontal axis represents the frequency of the high-frequency signal St. In FIGS. 4A and 4B, a frequency band BF0 centered around a frequency f0 is a frequency band to be transmitted to the second terminal P0.

In FIG. 4A, a frequency band BF1 centered around a frequency Fc (Fc=2×f0) is a frequency band targeted for attenuation (passing loss). In this case, the frequency Fc is a second harmonic of the frequency f0 (i.e., a signal having a frequency twice as high as the frequency f0).

In FIG. 4B, a frequency band BF2 centered around a frequency Fc (Fc=3×f0) is a frequency band targeted for attenuation (passing loss). In this case, the frequency Fc is a third harmonic of the frequency f0 (i.e., a signal having a frequency three times as high as the frequency f0).

In this way, the communication device 1 according to the first embodiment can remove (attenuate) a qth harmonic (q is a natural number) unnecessary for transmission from the high-frequency signal St using the second switching parts SW2_1 to SW2_n and the inductors L1 to Ln. Of course, the communication device 1 can attenuate a frequency band other than the harmonics by changing setting of the off capacitive components of the second switching parts SW2_1 to SW2_n and the inductances of the inductors L1 to Ln.

If the inductors L1 to Ln are not provided and a harmonic (a first harmonic) Sint of the high-frequency signal St shown in FIG. 2 overlaps with the frequency band of the high-frequency signal Sr, the harmonic Sint of the high-frequency signal St to be transmitted may interfere with the high-frequency signal Sr to be received and may deteriorate the reception performance of the communication device 1. For example, when the high-frequency signal St of a band 8 (about 880 MHz to about 915 MHz) is transmitted from the antenna ANTt and the high-frequency signal Sr of a band 3 (about 1805 MHz to about 1880 MHz) is received by the antenna ANTr, a second harmonic of the band 8 may interfere with reception of the signal of the band 3.

On the other hand, the high-frequency switching circuit 10 according to the first embodiment can attenuate the first harmonic Sint from the high-frequency signal St to be transmitted by appropriately setting the second switching parts SW2_1 to SW2_n and the inductors L1 to Ln. That is, the high-frequency switching circuit 10 can attenuate the harmonic Sint corresponding to the frequency band of the high-frequency signal Sr to be received by the antenna ANTr in advance from the high-frequency signal St.

For example, it is assumed that the harmonic Sint of the high-frequency signal St shown in FIG. 2 overlaps with the frequency band of a reception signal in the receiver RCV provided in the same terminal device as that including the switching circuit 10. It is also assumed that the first switching part SW1_1 passes the high-frequency signal St from the first terminal P1 to the second terminal P0. In this case, the first switching part SW1_1 is brought into a conduction state and the second switching part SW2_1 corresponding thereto is brought into a non-conduction state. Accordingly, the second switching part SW2_1 and the inductor L1 form the LC series circuit. When the second switching part SW2_1 and the inductor L1 are designed to attenuate the harmonic Sint, the harmonic Sint can be attenuated from the high-frequency signal St to be transmitted. As a result, the high-frequency switching circuit 10 according to the first embodiment can suppress interference of the harmonic of a transmission signal with a reception signal and accordingly suppress deterioration of the reception performance of the communication device 1.

According to the first embodiment, the inductors L1 to Ln are provided on the second switching parts (shunt parts) in the switching circuit 10, respectively. Therefore, it is unnecessary to add inductors outside the switching circuit 10, which enables reduction in the entire size of the communication device 1 and also enables reduction in the number of parts of the communication device 1.

### Second Embodiment

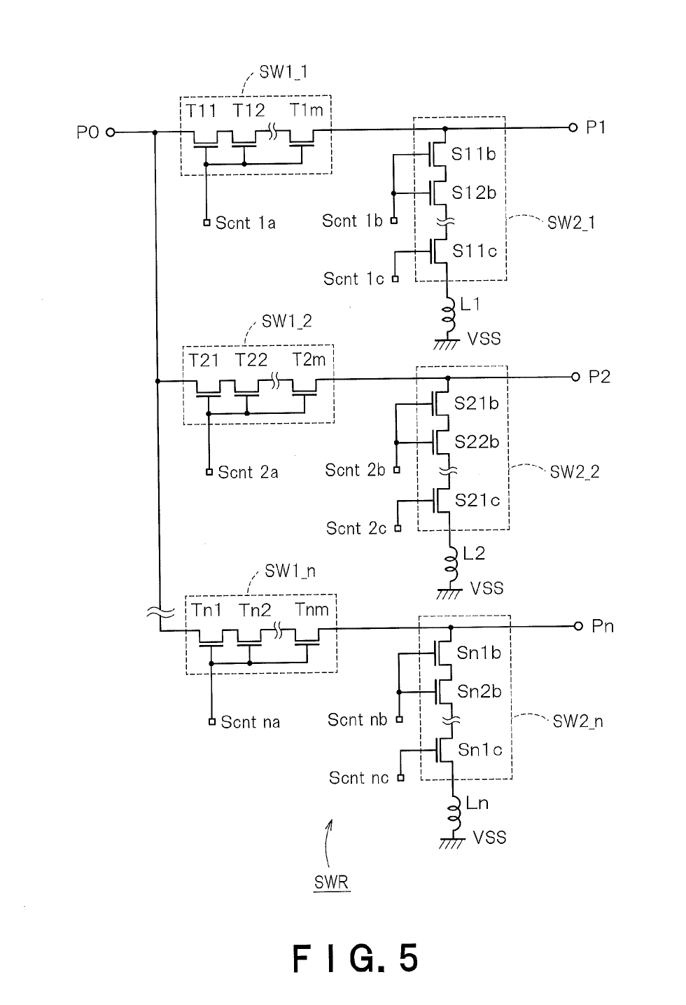

FIG. 5 is a circuit diagram showing an example of an internal configuration of the switching region SWR according to a second embodiment. In the second embodiment, the second switching parts SW2_1 to SW2_n (n is a natural number) include a plurality of transistors (S11b to S11c, S21b to S21c, . . . Sn1b to Sn1c) connected in series between the first terminals P1 to Pn and the reference voltage source VSS, respectively, similarly to the second switching parts in the first embodiment. However, in the second embodiment, each of the second switching parts SW2_1 to SW2_n is controlled by a plurality of control signals. For example, the second switching part SW2_1 is controlled by control signals Scnt1b and Scnt1c. The second switching part SW2_2 is controlled by control signals Scnt2b and Scnt2c. The second switching part SW2_n is controlled by control signals Scntnb and Scntnc.

The control signal Scnt1b controls the transistors S11b and S12b in the second switching part SW2_1 to be on/off. The control signal Scnt1c controls the transistor S11c in the second switching part SW2_1 to be on/off.

The control signal Scnt2b controls the transistors S21b and S22b in the second switching part SW2_2 to be on/off. The control signal Scnt2c controls the transistor S21c in the second switching part SW2_2 to be on/off. Other configurations of the second embodiment can be identical to corresponding ones of the first embodiment.

The control signal Scntnb controls the transistors Sn1b and Sn2b in the second switching part SW2_n to be on/off. The control signal Scntnc controls the transistor Sn1c in the second switching part SW2_n to be on/off.

With this configuration, the number of transistors that are brought into a conduction state or a non-conduction state in each of the second switching parts SW2_1 to SW2_n can be controlled. For example, when the second switching part SW2_1 is in a non-conduction state, the transistors S11b and S12b controlled by the control signal Scnt1b among the transistors S11b to S11c are brought into a non-conduction state and the transistor S11c controlled by the control signal Scnt1c is kept in a conduction state. In this case, the two transistors S11b and S12b and the inductor L1 form an LC series circuit and attenuate a signal of a predetermined frequency band from the high-frequency signal St. An off capacitive component of the two transistors S11b and S12b is assumed to be Csw2_2.

Alternatively, it is possible to bring the transistor S11c controlled by the control signal Scnt1c among the transistors S11b to S11c into a non-conduction state while keeping the transistors S11b and S12b controlled by the control signal Scnt1b in a conduction state. In this case, the transistor S11c and the inductor L1 form an LC series circuit and attenuate a signal of another frequency band from the high-frequency signal St. An off capacitive component of the transistor S11c is assumed to be Csw2_1.

Further alternatively, all of the transistors S11b to S11c can be brought into a non-conduction state. In this case, the three transistors S11b to S11c and the inductor L1 form an LC series circuit and attenuate a signal of still another frequency band from the high-frequency signal St. An off capacitive component of the three transistors S11b to S11c is assumed to be Csw2_3.

As described above, in the second embodiment, the number of transistors to be brought into a conduction state or a non-conduction state can be controlled in each of the second switching parts SW2_1 to SW2_n. That is, the number of transistors to be brought into a non-conduction state in each of the second switching parts (SW2_1, for example) is variable. This enables the off capacitive component of the second switching parts to be changed to one of Csw2_1 to Csw2_3. As a result, the switching circuit 10 can appropriately change the frequency band of a signal to be attenuated from the high-frequency signal St.

For example, when the first switching part SW1_1 passes the high-frequency signal St from the first terminal P1 to the second terminal P0, the first switching part SW1_1 is brought into a conduction state and the second switching part SW2_1 is brought into a non-conduction state. When the frequency band of a reception signal in the receiver RCV shown in FIG. 2 is changed, the harmonic to be attenuated from the high-frequency signal St in the second switching part SW2_1 also needs to be changed. In this case, by changing the number of transistors to be brought into a non-conduction state in the second switching part SW2_1, the switching circuit 10 can change the frequency band of the harmonic to be attenuated from the high-frequency signal St so as to be adapted to the frequency band of the reception signal. That is, the number of transistors to be brought into a non-conduction state in the second switching part SW2_1 corresponding to the first switching part SW1_1 in a conduction state can be set to attenuate a harmonic that overlaps with the frequency band of the reception signal from the high-frequency signal to be transmitted.

The frequency band of a signal that can be received by the receiver RCV is often known in advance. Therefore, the number of transistors to be brought into a non-conduction state in the second switching part can be set in such a manner that the frequency band of a harmonic to be attenuated from the high-frequency signal St is adapted to the frequency band of the reception signal. It suffices that the controller CNT changes logic of the control signals (Scnt1b and Scnt1c, for example) to adapt the frequency band of the harmonic to be attenuated from the high-frequency signal St to the frequency band of the reception signal correspondingly to a timing of change of the frequency band of the reception signal.

Accordingly, even when the frequency band of the reception signal in the receiver RCV is changed, the switching circuit 10 can change the harmonic to be attenuated from the high-frequency signal St by changing the number of transistors to be brought into a non-conduction state in the second switching part.

On the other hand, when a first switching part is in a non-conduction state and the corresponding second switching part is to be brought into a conduction state, it suffices to bring all transistors included in the second switching part that is to be brought into a conduction state into a conduction state. For example, when the second switching part SW2_1 is to be brought into a conduction state, it suffices that the control signals Scnt1b and Scnt1c bring all of the transistors S11b to S11c into a conduction state. This causes the first terminal P1 to be shunted to the reference voltage source VSS.

In the second embodiment, the transistors in each of the second switching parts SW2_1 to SW2_n are divided into two groups and are controlled by two control signals, respectively. However, the transistors in each of the second switching parts SW2_1 to SW2_n can be divided into three or more groups. When the number of groups of the transistors is increased, the switching circuit 10 can attenuate signals of more frequency bands.

Other operations of the second embodiment can be identical to corresponding ones of the first embodiment. Accordingly, the second embodiment can also achieve effects of the first embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A semiconductor device comprising:
a first terminal receiving a high-frequency signal as an input;
a second terminal outputting the high-frequency signal;
a first switching part provided on a path of the high-frequency signal between the first terminal and the second terminal; and
a second switching part and an inductor connected in series between the first terminal and a reference voltage source, wherein
the second switching part is in a conduction state to electrically connect the first terminal to the reference voltage source when the first switching part is in a non-conduction state, and
the second switching part is in a non-conduction state when the first switching part is in a conduction state.

2. The device of claim 1, wherein the second switching part and the inductor attenuate a signal of a predetermined frequency band among the high-frequency signals when the first switching part is in a conduction state and the second switching part is in a non-conduction state.

3. The device of claim 1, wherein
a plurality of the first terminals are provided,
the second terminal is common to the first terminals,
a plurality of the first switching parts are provided between the first terminals and the second terminal, respectively,
a plurality of the second switching parts and a plurality of the inductors are provided between the first terminals and the reference voltage source, respectively,
a first switching part selected from among the first switching parts is brought into a conduction state to connect one of the first terminals corresponding to the selected first switching part to the second terminal, and
one of the second switching parts corresponding to the selected first switching part is brought into a non-conduction state.

4. The device of claim 2, wherein
a plurality of the first terminals are provided,
the second terminal is common to the first terminals,
a plurality of the first switching parts are provided between the first terminals and the second terminal, respectively,
a plurality of the second switching parts and a plurality of the inductors are provided between the first terminals and the reference voltage source, respectively,
a first switching part selected from among the first switching parts is brought into a conduction state to connect one of the first terminals corresponding to the selected first switching part to the second terminal, and
one of the second switching parts corresponding to the selected first switching part is brought into a non-conduction state.

5. The device of claim 1, wherein the second switching part and the inductor attenuate a qth harmonic (q is an integer) of the high-frequency signal when the first switching part is in a conduction state and the second switching part is a non-conduction state.

6. The device of claim 2, wherein the second switching part and the inductor attenuate a qth harmonic (q is an integer) of the high-frequency signal when the first switching part is in a conduction state and the second switching part is a non-conduction state.

7. The device of claim 3, wherein the second switching part and the inductor attenuate a qth harmonic (q is an integer) of the high-frequency signal when the first switching part is in a conduction state and the second switching part is a non-conduction state.

8. The device of claim 5, wherein
the high-frequency signal is transmitted from an antenna connected to the second terminal, and
in a case where a first harmonic of the high-frequency signal overlaps with a frequency band of a reception signal in a receiver provided in a same terminal device as that including the semiconductor device, the second switching part and the inductor attenuate the first harmonic of the high-frequency signal when the first switching part is in a conduction state and the second switching part is in a non-conduction state.

9. The device of claim 1, wherein the first and second terminals, the first and second switching parts, and the inductor are included in a single semiconductor chip.

10. The device of claim 2, wherein the first and second terminals, the first and second switching parts, and the inductor are included in a single semiconductor chip.

11. The device of claim 3, wherein the first and second terminals, the first and second switching parts, and the inductor are included in a single semiconductor chip.

12. The device of claim 1, wherein the second switching part has a capacitive component when the second switching part is in a non-conduction state.

13. The device of claim 1, wherein
the second switching part comprises a plurality of transistors connected in series between the first terminal and the reference voltage source, and
number of the transistors to be brought into a non-conduction state in the second switching part when the first switching part is in a conduction state is variable.

14. The device of claim 2, wherein
the second switching part comprises a plurality of transistors connected in series between the first terminal and the reference voltage source, and
number of the transistors to be brought into a non-conduction state in the second switching part when the first switching part is in a conduction state is variable.

15. The device of claim 3, wherein
the second switching part comprises a plurality of transistors connected in series between the first terminal and the reference voltage source, and
number of the transistors to be brought into a non-conduction state in the second switching part when the first switching part is in a conduction state is variable.

16. The device of claim 5, wherein
the second switching part comprises a plurality of transistors connected in series between the first terminal and the reference voltage source, and
number of the transistors to be brought into a non-conduction state in the second switching part when the first switching part is in a conduction state is variable.

17. The device of claim 8, wherein
the second switching part comprises a plurality of transistors connected in series between the first terminal and the reference voltage source, and
number of the transistors to be brought into a non-conduction state in the second switching part when the first switching part is in a conduction state is variable.

18. The device of claim 13, wherein
the high-frequency signal is transmitted from an antenna connected to the second terminal, and
in a case where a first harmonic of the high-frequency signal overlaps with a frequency band of a reception signal in a receiver provided in a same terminal device as that including the semiconductor device, number of the transistors to be brought into a non-conduction state in the second switching part when the first switching part is in a conduction state is set to attenuate the first harmonic.
